(19) United States
(12) Patent Application Publication
(10) Pub. No.: US 2005/0163302 A1
(43) Pub. Date: Jul. 28, 2005

(54) Customer service system and method using physiological data

(76) Inventors: Von A. Mock, Boynton Beach, FL (US); Amy M. Tupler, Hollywood, FL (US)

Correspondence Address: AKERMAN SENTERFITT, P.O. BOX 3188, WEST PALM BEACH, FL, 33402-3188, US

(21) Appl. No.: 10/762,974

(22) Filed: Jan. 22, 2004

(51) Int. Cl. H04M 3/42

(52) U.S. Cl. 379/211.02

(57) ABSTRACT

A customer service method (300) for handling calls to or from a plurality of callers can include the steps of retrieving non-vocal physiological data from a caller (311), assigning a priority (313) to the caller in response to retrieving non-vocal physiological data from the caller, and routing (315) the caller based on the priority assigned to the caller. The method can further include the step of retrieving vocal physiological data (417, 423 540, or 513) from the caller and assigning the priority in response to retrieving both the non-vocal physiological data and vocal physiological data. The routing of the caller can also be based on the priority assigned to the caller and a value determined for the caller from a profile for the caller. Priority given to low and high valued callers can be altered based on when and what physiological data is received.

### CROSS-REFERENCE TO RELATED APPLICATIONS

Not applicable

### FIELD OF THE INVENTION

This invention relates generally to customer service systems, and more particularly to a system using physiological data gathered from a caller.

### BACKGROUND OF THE INVENTION

Customer service centers typically spend 75% of their time on 20% of the customers that typically pay for the lowest level of service. There is a desire in the customer service industry to transform the customers who utilize the resources the most to a higher level of payment. This transformation allows the customer service center to turn unprofitable customers into either a profitable customer or a former customer.

In another aspect some industry businesses have reported that 17 percent of its customers accounted for 93 percent of its profits. In this example being able to identify these customers and making sure that they are kept happy while calling customer service centers are key to the profitability of the business. Some businesses utilize a phone system that uses technology that identifies the caller, and if the caller is a highly profitable customer he or she is automatically routed to service representatives with training in that customer's particular interests and needs. Several systems exist today that allow the call service center to determine within an approximate confidence level the emotional state of the caller. This information could be utilized to determine if the best paying customer is happy within a degree of confidence while the sad or angry state of a user could provide information helpful to the service center to transform an unhappy, but profitable customer into a happier customer or the unprofitable customer into a profitable one.

Existing systems that attempt determine such an emotional status of a caller rely on voice analysis of the customer based upon history of the customer that does not provide a high level of accuracy and confidence. For example, U.S. Pat. No. 6,480,826 discusses an experiment that utilizes voice recording to determine the emotion state of the user. In a portion of the experiment, the emotional voice analysis of Angry and Sad have the highest probability of being determined with 72.2% and 68.3% accuracy with a standard deviation of 5.3 and 7.8 respectively. However, determining the emotions of happy, normal and afraid from the voice analysis have lower probabilities of being correctly identified with higher standard deviations using voice and history analysis only. Clearly, such systems that solely rely on voice analysis and history profiles to determine an emotional state of a caller or customer fail to provide the level of service, predictability and profitability call centers are seeking. Furthermore, such existing systems further fail to place a caller at ease or provide for behavior training in response to detecting a certain emotional state.

### SUMMARY OF THE INVENTION

A customer service system and method can utilize non-vocal physiological data obtained from a user of a communication device to further enhance the customer service system in terms of responsiveness, profitability, or other criteria as desired. Such non-vocal physiological data can include an applied pressure to a phone used by the caller, a heart rate of the caller, a skin conductivity of the caller, an ambient noise level around the phone caller, a body temperature of the caller, a breath analysis of the caller, or an ambient temperature around the phone caller. The system can also retrieve a profile for the caller or customer to determine a value for the customer. The non-vocal physiological data can also be used in conjunction with vocal physiological data or the profile to further enhance results.

In one embodiment of the present invention, a customer service method for handling calls to or from a plurality of callers can include the steps of retrieving non-vocal physiological data from a caller, assigning a priority to the caller in response to retrieving non-vocal physiological data from the caller, and routing the caller based on the priority assigned to the caller. The method can further include the step of retrieving vocal physiological data from the caller and assigning the priority in response to retrieving both the non-vocal physiological data and vocal physiological data. The routing of the caller can also be based on the priority assigned to the caller and a value determined for the caller from a profile for the caller. Thus, in one aspect, the priority given to a high valued caller can be increased when negative non-vocal physiological data is received from the caller and can also be decreased for a low valued caller. Alternatively, behavior modification techniques can be used with a low valued caller when negative non-vocal physiological data is received from the caller. In another aspect, a predetermined presentation (such as a sound presentation, a picture presentation, a multi-media presentation, or a video presentation) can be sent to the caller based on the non-vocal physiological data retrieved from the caller.

In a second embodiment of the present invention, a customer service system for handling calls to or from a plurality of callers can include an analyzer for analyzing non-vocal physiological data retrieved from a caller and a processor. The processor can be programmed to assign a priority to the caller in response to retrieving and analyzing the non-vocal physiological data from the caller and route the caller based on the priority assigned to the caller. The analyzer can further analyze vocal physiological data from the caller and the processor can further be programmed to assign the priority in response to the non-vocal physiological data and the vocal physiological data.

In a third embodiment of the present invention, a communication device can include a transceiver, a non-vocal physiological detection sensor coupled to the transceiver, and a processor coupled to the transceiver. The processor can be programmed to transmit non-vocal physiological data to a third party to alter a call processing procedure at the third party. The processor can be further programmed to receive instructions from the third party altering a presentation on the presentation device. The third party, for example, can be a call center. The communication device can further include a presentation device such as a display or speaker coupled to the transceiver and the processor.

### BRIEF DESCRIPTION OF THE DRAWINGS

FIG. 1 is a block diagram of a communication system having a call center for handling calls in accordance with an embodiment of the present invention.

FIG. 2 is an illustration of a communication device capable of providing non-vocal physiological data to a third party in accordance with an embodiment of the present invention.

FIG. 3 is a flow chart illustrating a customer service method for handling calls using non-vocal physiological data in accordance with an embodiment of the present invention.

FIG. 4 is a flow chart illustrating a customer service method for handling calls from high valued customers using non-vocal physiological data in accordance with an embodiment of the present invention.

FIG. 5 is a flow chart illustrating a customer service method for handling calls from low valued customers using non-vocal physiological data in accordance with an embodiment of the present invention.

### DETAILED DESCRIPTION OF THE DRAWINGS

An embodiment in accordance with the present invention can utilize a cellular phone, a mobile device, or any other device with communications capability to report non-vocal (as well as vocal) physiological information to a customer service call center to increase the probability of determining the right emotion of the customer or caller. Note that although the examples illustrated use a mobile device, other embodiments contemplated within the scope of the claims can certainly use a wire-line connection that still provides the non-vocal physiological information to a third party such as call center.

Cellular and other mobile devices can be more cognizant of their surrounding by the inclusion of sensor aware capabilities. Such sensors can provide the capability to determine heart rate, perspiration, and body temperature to name a few. In addition, a cellular or other mobile communication device can provide other information that could be utilized by a call service center to better serve the customer. Some of the additional information can include location, background noise, time of day, movement or acceleration and a user's calendar events or preferences.

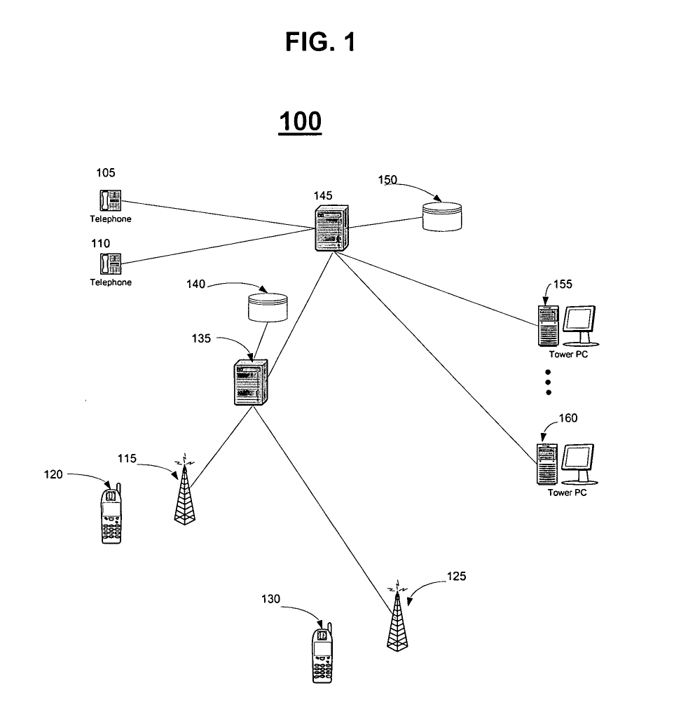

Referring to FIG. 1, a communication system 100 including a customer service system for handling incoming calls to or from a plurality of callers can include an analyzer for analyzing non-vocal physiological data retrieved from a caller and a processor programmed to assign a priority to the caller in response to retrieving and analyzing the non-vocal physiological data from the caller and route the caller based on the priority assigned to the caller. The communication system 100 can be embodied in the form of a call center having a gateway or switching center 145 and a plurality or bank of phones 105 and 110 for handling a plurality of inbound and outbound calls. Call center operators can have access to caller profiles or histories in a database 150. The database can also retain information regarding the value of a particular caller or customer based on the history in the database and other information. Each call center can use their own determination or algorithm as to what value is assigned to a particular customer or caller. The system 100 can also include a plurality of computers 155 and 160 that can include software and other hardware as necessary to serve as the analyzer and processor described above. Such computers can also include the algorithms for determining the value of a particular caller or customer. Additionally, the communication system can further include a plurality of mobile base stations 115 and 125 for receiving voice and/or data information from a plurality of transceivers 120 and 130. The transceivers 120, 130 can be cellular phones, trunked radios, two-way paging devices or other two-way communication devices that are able to transmit non-vocal physiological data perceptible by the call center. The mobile base stations 115,125 can be coupled to a mobile switching center 135 having access to a database 140 containing information about a particular caller. The database 140 can be configured to allow access or share information with the call center and the database 150.

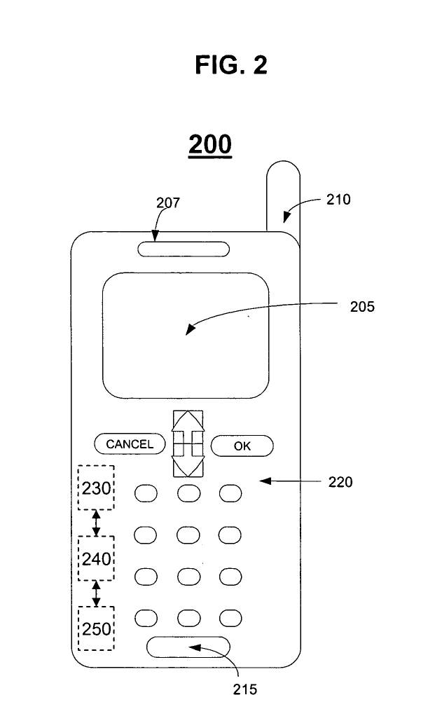

Referring to FIG. 2, a communication device 200 is illustrated having a user interface in the form of a keypad 220, a speaker 207, microphone 215, antenna 210, and a presentation device in the form of a display 205. The communication device further includes a transceiver 240, a non-vocal physiological detection sensor 230 coupled to the transceiver 240, and a processor 250 coupled to the transceiver 240 and sensor 230. The processor 250 can be programmed to transmit non-vocal physiological data to a third party to alter a call processing procedure at the third party such as the call center described with respect to system 100 of FIG. 1. The processor 250 can be further programmed to receive instructions from the third party altering a presentation on the presentation device. For example, calming music can be played from the speaker 207 or a soothing wallpaper or video can be played on the display 205 when instructions from the call center is received in response to determining that the emotional state of the caller is angry or agitated. Of course, other presentations evoking other desired emotions can be presented as well.

Examples of the types of non-vocal physiological data that can be obtained is illustrated by U.S. Pat. No. 6,491,647 entitled “Physiological sensing device” which describes a non-invasive device for measuring physiological processes. More particularly, it concerns a device that can be applied externally to the body of a human to detect and quantify displacement, force, motion, vibration and acoustic effects resulting from internal biological functions. During physical activity, the device reflects the level of effort being exerted overwhelming over any other physiologically derived signals, and during quiet rest periods it becomes sensitive to the body's internal “ballistics” such as breathing, tremor, and heart and arterial pulsation. Another reference, U.S. Pat. No. 5,490,505 to Diab et al. describes a device that can be incorporated into a wireless or wire line headset typically used within a cellular phone hands free environment. The device can be configured to work on the ear with two different wavelength LED's shining through the tissue to enable an attenuation measurement to be made after propagation through or reflection from the medium. Pulse rate is determined from the periodic attenuation associated with the increase and decrease in arterial flow during a pulse cycle. Another Physiological data input is the measurement of arousal of the customer. U.S. Pat. No. 6,415,176 entitled “Sensing and display of skin conductivity” describes a system that measures the sense of arousal. Arousal is measured through the skin conductivity response also known as the electrodermal response. The skin momentarily becomes a better conductor of electricity in response to external or internal stimuli that is physiologically arousing. Arousal is widely considered one of the two main dimensions of an emotional response; the other, valence, represents the positive or negative quality of the response (so that winning an award is high arousal, positive valence whereas listening to a boring speech is low arousal, negative valence). Measuring arousal is therefore not the same as measuring emotion, but does capture an important component of it. Arousal has been found to be a strong predictor of attention and memory. Arousal level tends be low when a person is sleeping, and high in activated states such as rage or mental workload. Engaging in a task that imposes mental workload, such as solving math problems (even if not particularly difficult), will tend to cause skin conductivity to increase sharply and then gradually decline.

Another non-vocal physiological characteristic is the pressure applied to a particular device. For example, U.S. Pat. No. 5,184,628 entitled “Grip sincerity assessment system and method” discusses the assessment of the sincerity or genuineness of the grip exerted by a subject over a period of time while a measurement is being made. This concept when incorporated into a cellular phone or other mobile device can determine the grip pressure applied to the mobile device by the user. This grip pressure along with other physiological data recording sensors within a mobile device can be utilized to determine the appropriate emotion of the user. Similarly, the ability to measure the temperature of the person as achieved in the popular Braun Ear Thermometer or as described in U.S. Pat. No. 6,637,931 entitled “Probe for use in an infrared thermometer” can provide additional information as to the state of the user. A high temperature reading would indicate the individual is not feeling well and would be reflected in how the customer service representative handles the caller. For example, a person with a fever having paid for or otherwise earned a premium level of service would be put to the front of the queue and/or be given a higher priority. Alternatively, if the person with the high temperature were placed on hold, the type of music or other information would not contain high rhythmic or loud sounds to better comfort the user.

Research in the emotional state of a speaker being recognized by a human was studied in a study called “Emotion of Speech: Recognition and application to call centers”. As part of the research, an experiment was devised to what kinds of emotions are easier/harder to recognize based on the utterances. The experiment involved actors that recorded utterances depicting the emotions; normal, happy, angry, sad and afraid. While a group of 23 other test subjects evaluated the utterances and tried to determine the emotion. Table 1 below shows the performance confusion matrix that is a result of this experiment. The rows and columns represent true and evaluated categories respectively, for example, second row says that 11.9% of utterances that were portrayed as happy were evaluated as normal (unemotional), 61.4% as true happy, 10.1% as angry, 4.1% as sad and 12.5% as afraid. From this table, the most recognizable category is anger (72.2%) and the least easily recognizable category is fear (49.5%). A lot of confusion is going on between sadness and fear, sadness and unemotional state and happiness and fear. From the table, it can be surmised that people better understand how to express and decode anger and sadness than other emotions.

TABLE 1
Performance Confusion Matrix

| Category | Normal | Happy | Angry | Sad | Afraid | Total |
|---|---|---|---|---|---|---|
| Normal | 66.3 | 2.5 | 7.0 | 18.2 | 6.0 | 100% |
| Happy | 11.9 | 61.4 | 10.1 | 4.1 | 12.5 | 100% |
| Angry | 10.6 | 5.2 | 72.2 | 5.6 | 6.3 | 100% |
| Sad | 11.8 | 1.0 | 4.7 | 68.3 | 14.3 | 100% |
| Afraid | 11.8 | 9.4 | 5.1 | 24.2 | 49.5 | 100% |

Cellular phones or other mobile communication devices incorporating sensors described herein will aid customer service representatives to better ascertain the emotional state of the user and provide the appropriate quality of service based on a value assigned to a customer. The value assigned to a particular customer can be based on various factors including, but not limited to, customer history, service level contracts purchased, overall revenue from a customer, revenue per call, revenue per call time, emotional state, among other factors.

In summary, non-vocal physiological data and the emotional status information deduced from such information can include: a) Increased grip pressure—where such indication can increase the probability of choosing angry (frustration) or afraid as the correct emotion by a service representative; or b) Decreased grip pressure—where such indication can increase the probability of choosing happy or sad emotion by the service representative; or c) Increased heart rate—where such indication can increase the probability of choosing angry or afraid; or d) Decreased heart rate—where such indication can increase the probability of choosing happy or sad emotion by the service representative; or e) Increased Arousal (skin conductivity)—wherein such indication can increase the probability of choosing a high state of emotion such as angry or afraid by the service representative; or f) Decreased Arousal—where such indication can increase the probability of choosing the normal or sad state by the service representative g) A Breath Content Level or a Breath Rate—wherein such indication can determine a possible medically impaired state of the caller resulting for example from a high alcohol intake or a low blood sugar level in a diabetic patient in serious distress or an Asthmatic condition. In addition, other aspects of arousal can be utilized by the service representative to ascertain a heighten level of memory and concentration so that more technical details can be covered during this time.

In another scenario, ambient temperature recorded by the mobile device in a user's surroundings and reported data back to the service representative can also be used by a call center to improve service. For example, a high surrounding ambient temperature level would be important to a call service center that deals with automotive breakdowns such as AAA or Amoco motor clubs. Getting service quickly to the user would be advantageous for elite service club members who are experiencing extreme surrounding temperatures. Other aspects of day or night conditions can be employed by the service representative to better serve the customer. For example, a car breakdown in the middle of the afternoon in a strange neighborhood would create a different user emotion if the same instance occurred late at night. In a particular instance the call representative can receive physiological data showing a caller is becoming afraid or has a high anxiety level and may need police or other escort until AAA or Amoco motor club arrives.

In another embodiment, audio and visual presentations can be used to alter the emotional state of a caller or customer in response to determine a predetermined emotional state. For example, behavior modification techniques can be used with a low or high valued caller when negative non-vocal physiological data is received from the caller. In such an instance, a predetermined presentation (such as a sound presentation, a picture presentation, a multi-media presentation, or a video presentation) can be sent to the caller based on the non-vocal physiological data retrieved from the caller.

Research data shows that the visual reception of certain types of surrounding scenery produces a calming effect depending on the original state of the user. For example, fish tanks and similar scenery provide a calm and relax state to a nervous person and desert or mountain scenery provides a calming effect for an angry and agitated person. In one aspect, call centers can utilize the color display screen available on a mobile device to push wallpaper and sound themes that would provide a calming effect based on the original emotional state of the user, e.g. fish and sound themes for nervous callers and mountain, desert themes for angry/agitated callers. A recent study in Miami found that adults who listen regularly to “soothing music” reported feeling less fatigue and depression after just six weeks of regular listening. In addition, their levels of cortisol, a stress hormone in the blood, dropped significantly. Further, this effect lasted for seven weeks after the listening study ended. (Forbes FYI, 4/98) Many studies have shown that slow, relaxing, soothing music has a stunningly positive impact on learning, creativity, and memory. Further, such music has many beneficial effects on health, and is used in countless therapeutic situations. (For an in-depth discussion of these studies, see the book, The Mozart Effect, by John Morrison.) At Piedmont Hospital in Atlanta (and in many other locations as well), doctors use soothing music in the neonatal unit to calm premature babies. This environment allows all their energy to be used and focused for growing and not wasted on fretting and crying. (from an article by former Georgia Governor, Zell Miller, in The Atlanta Constitution, Aug. 31, 1999)

On the other hand, loud noise (including loud music) can, according to a study in the Journal of Environment and Behavior, slow down learning and raise stress levels. Loud noise can even delay the development of speaking skills in children. Such loud noise causes anger, aggression, poor performance and insomnia. That's why loud rock music is often used as a “weapon” by police departments and military forces. (Reported in The Atlanta Constitution, May 8, 1997)

Additionally, a system using non-vocal physiological data can also benefit from using vocal physiological data. Such vocal physiological data can track the rate of use of the word “I” or “me” or sounds like “grrr” in speech patterns to also determine the users state of mind. Use of “I” is very “ME” focused and could determine the anger level of the caller. Even tracking the use of the word “you” in a call center environment can assist. Additionally, physiological recording of data around these particular words would give a strong correlation to anger or afraid emotions and would allow for the customer service representative to best serve the caller.

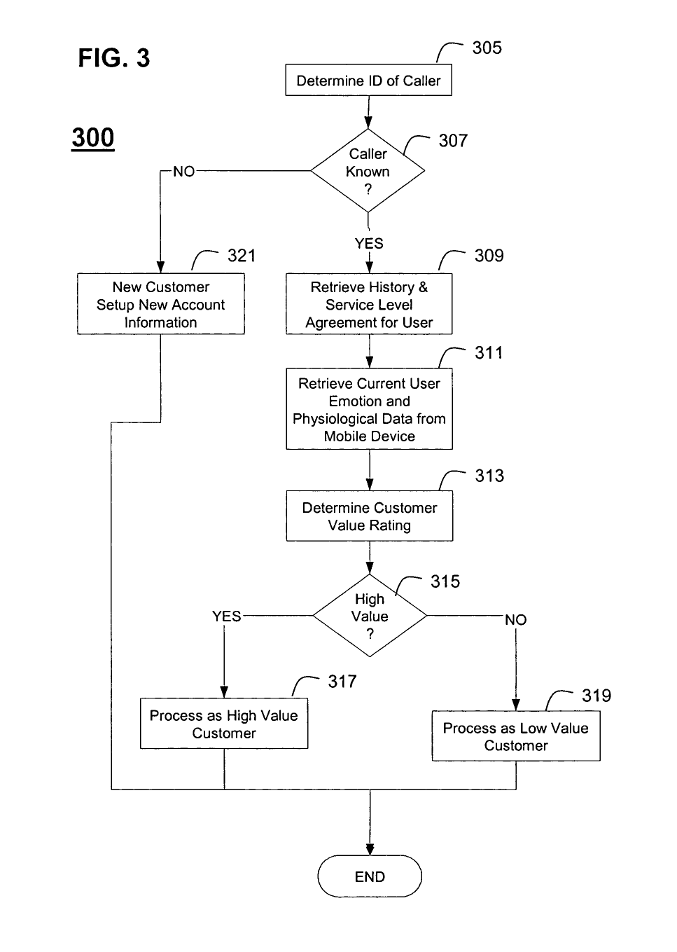

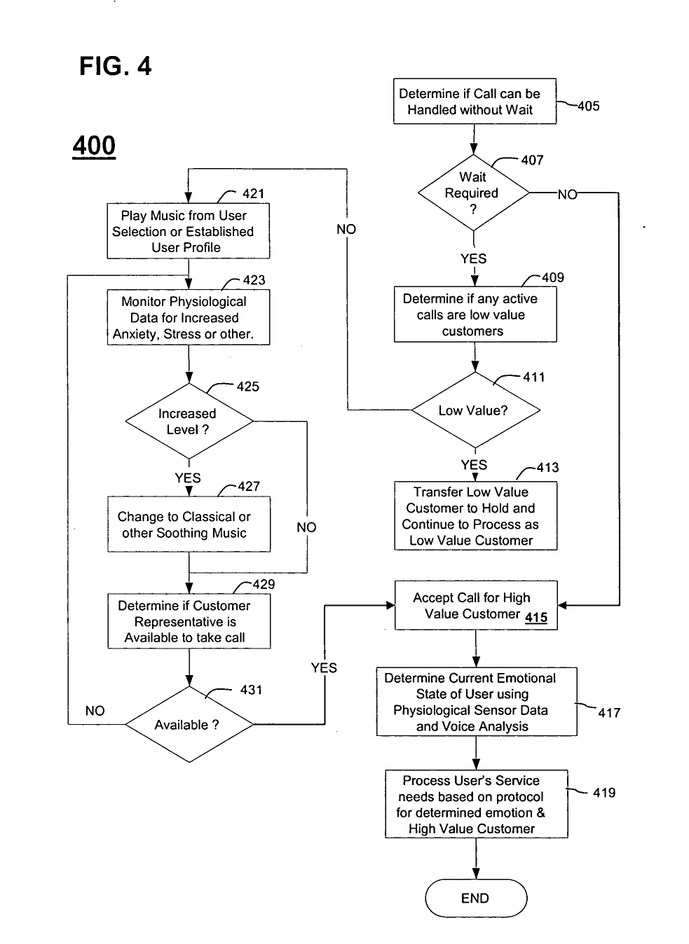

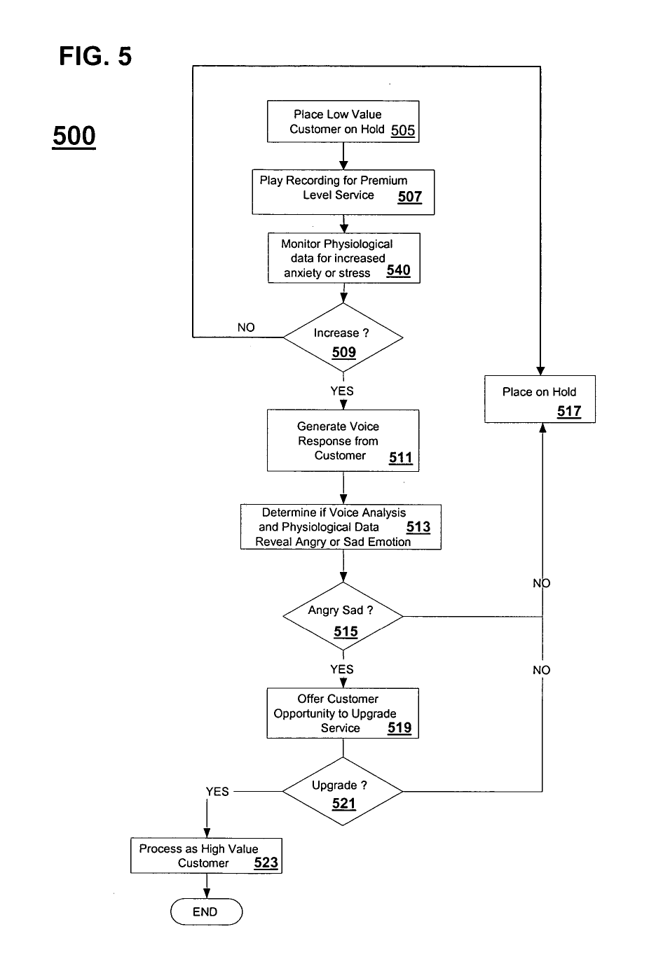

Referring to FIGS. 3-5, exemplary flow charts illustrating a customer service method 300 for handling calls using non-vocal physiological data in accordance with an embodiment of the present invention is shown. A customer service method 400 for handling calls from high valued customers using non-vocal physiological data is shown in FIG. 4 while a customer service method 500 for handling calls from low valued customers is shown in FIG. 5. The method 300 can begin by determining the identity of a caller at step 305. If the caller is unknown to the system at decision block 307, then method 300 can proceed to set up a new record for the caller or customer at step 321. If the caller is known at decision block 307, then the caller history can be retrieved at step 309. Additionally, if the caller paid or otherwise earned a predetermined level of service via a service level agreement, for example, such information can also be retrieved at step 309. Assuming a phone or other device capable of providing non-vocal physiological data is being used by the caller or customer, the current user emotional state is determined from the retrieved physiological data transmitted at step 311. Optionally, a value rating can be determined for the caller or customer at step 313. This value rating can be determined from a customer profile or their history or from a combination of factors including the emotional status determined at step 311. At decision block 315, if the customer value is determined to be high, then the call is processed at step 317 and otherwise the call is processed at step 319 as a low value customer.

If the call is to be processed for a high valued customer or caller at step 317, then the customer service method 400 of FIG. 4 for handling calls from high valued customers using non-vocal physiological data can be used. The method 400 begins by determining if the call can be handled without waiting at step 405. If no wait is required at decision block 407, then the call is accepted and processed for a high valued customer or caller at step 415. If a wait is required at decision block 407, then it is determined if any active calls are for low valued customers at step 409. If low valued calls are active at decision block 411, then such calls are transferred to hold and continued to process as low valued customers or callers at step 413. If the callers are not low valued at decision block 411, then music can be played optionally from a user selection or a user profile at step 421. The method 400 can continue at step 423 by monitoring physiological data for increased anxiety, stress or other emotional state. At decision block 425, if the emotional state increases in anxiety, anger, stress or other negative emotion, then the music or other presentation played to the caller can be changed to a more soothing presentation such as classical music at step 427. If the emotional state does not increase at decision block 425, then it can be determined if a customer service representative is available. If the customer service representative if available at decision block 431, then the call is accepted and processed as a high valued customer at step 415. The method 400 can proceed by continuing to determine and monitor the current emotional state of the caller using physiological sensor data and optionally voice analysis at step 417. At step 419, the method 400 can continue to process the high valued customer or caller based on the protocol for such high valued customer and the current determined emotional state of the caller.

If the call is to be processed for a low valued customer or caller at step 319 (of FIG. 3), then the customer service method 500 of FIG. 5 for handling calls from low valued customers using non-vocal physiological data can be used. The method 500 begins by placing the low valued caller or customer on hold at step 505. At step 507, the method 500 can optionally play a recording offering a premium or better level of service than the caller is currently receiving. At step 540, physiological data from the caller can be monitored for increased anxiety, anger, stress or other negative emotion. If no increase in the negative emotion is detected at decision block 509, then the caller continues to be placed on hold at step 517. If an increase in the negative emotion is detected at decision block 509, then a voice response from the caller or customer is solicited at step 511. At step 513, a determination of whether an angry or sad emotion is indicated using physiological data and a voice analysis. If an angry or sad emotion is indicated at decision block 515, then the customer or caller is offered an opportunity to upgrade their service at step 519. If the customer or caller does not wish to upgrade at decision block 521, then the caller continues to be placed on hold at step 517. Likewise, if no angry or sad emotion is indicated at decision block 515, then the caller continues to be placed on hold at step 517. If the customer or caller decides to upgrade their service, then the caller or customer can be processed as a high valued customer at step 523.

Other variations along the same lines described in the methods 300, 400, and 500 above can be used in other scenarios which are all contemplated within the scope of the present invention. For example, a method can determine an arousal state of a user and relaying this information to the call center so that the customer service representative can determine if a follow up multimedia message is needed since the user has a low arousal indicating low attention and memory. In other exemplary scenarios, such a system can use reported changes in grip pressure in a mobile device enable a call center to perform various tasks that can increase profitability and overall customer service. For example, detecting an increased grip pressure and a high paying customer would indicate a danger of severe customer dissatisfaction and a need to provide immediate and prioritized assistance. Detecting low grip pressure and a low paying customer can indicate continued processing as low value customer whereas a high grip pressure and low paying customer can indicate the performance of behavior modification techniques (e.g. place on hold, play music with voice over recording stating the value you will receive when you make the choice of becoming a high valued customer or drop the call).

In yet another scenario, loud or fast beat music can be played to low paying customers while monitoring the physiological data and switching over to softer music with a voice over to describe the opportunity to upgrade to the premium level plan. Later the loud or fast beat music can be switched back when the heart rate of the user is lowered to a predetermined level. This cycle can continue for a period of time before actually helping the customer.

In light of the foregoing description, it should be recognized that embodiments in accordance with the present invention can be realized in hardware, software, or a combination of hardware and software. A communications system or device or method according to the present invention can be realized in a centralized fashion in one computer system or processor, or in a distributed fashion where different elements are spread across several interconnected computer systems or processors (such as a microprocessor and a DSP). Any kind of computer system, or other apparatus adapted for carrying out the functions described herein, is suited. A typical combination of hardware and software could be a general purpose computer system with a computer program that, when being loaded and executed, controls the computer system such that it carries out the functions described herein.

Additionally, the description above is intended by way of example only and is not intended to limit the present invention in any way, except as set forth in the following claims.

1. A customer service method for handling calls to or from a plurality of callers, comprising the steps of:
retrieving non-vocal physiological data from a caller;
in response to retrieving non-vocal physiological data from the caller, assigning a priority to the caller; and
routing the caller based on the priority assigned to the caller.

2. The method of claim 1, wherein the method further comprises the step of retrieving vocal physiological data from the caller.

3. The method of claim 2, wherein the step of assigning the priority is in response to retrieving non-vocal physiological data and vocal physiological data.

4. The method of claim 1, wherein the step of retrieving non-vocal physiological data comprises the step of retrieving at least one among an applied pressure to a phone used by the caller, a heart rate of the caller, a breath content of the caller, a breath rate of the caller a skin conductivity of the caller, an ambient noise level around the phone caller, a body temperature of the caller, and an ambient temperature around the phone caller.

5. The method of claim 1, wherein the method further comprises retrieving a profile for the caller to determine a value for the caller.

6. The method of claim 5, wherein the step of routing the caller is based on the priority assigned to the caller and the value determined for the caller.

7. The method of claim 6, wherein the method further comprises the step of increasing the priority given to a high valued caller as determined by the profile of the caller when negative non-vocal physiological data is received from the caller.

8. The method of claim 6, wherein the method further comprises the step of decreasing the priority given to a low valued caller as determined by the profile of the caller when negative non-vocal physiological data is received from the caller.

9. The method of claim 6, wherein the method further comprises the step of performing behavior modification techniques on a low valued caller as determined by the profile of the caller when negative non-vocal physiological data is received from the caller.

10. The method claim 1, wherein the method further comprises the step of sending a predetermined presentation to the caller based on the non-vocal physiological data retrieved from the caller.

11. The method of claim 10, wherein the predetermined presentation is at least one among a sound presentation, a picture presentation, a multimedia presentation, and a video presentation.

12. The method of claim 11, wherein the sound presentation is at least one among a calming music presentation, an irritating music presentation, a calming voice presentation, and an irritating voice presentation and the picture presentation is at least one among a calming picture presentation and an irritating picture presentation, and the multimedia presentation is at least one among a calming multimedia presentation and an irritating multimedia presentation, and the video presentation is at least one among a calming video presentation and an irritating video presentation

13. A customer service system for handling calls to or from a plurality of callers, comprising:
an analyzer for analyzing non-vocal physiological data retrieved from a caller; and
a processor programmed to:
assign a priority to the caller in response to retrieving and analyzing the non-vocal physiological data from the caller; and
route the caller based on the priority assigned to the caller.

14. The system of claim 13, wherein the analyzer further analyzes vocal physiological data from the caller and the processor is further programmed to assign the priority in response to the non-vocal physiological data and the vocal physiological data.

15. The system of claim 13, wherein the non-vocal physiological data comprises at least one among an applied pressure to a phone used by the caller, a heart rate of the caller, a skin conductivity of the caller, a breath content of the caller, a breath rate of the caller, an ambient noise level around the phone caller, a body temperature of the caller, and an ambient temperature around the phone caller.

16. The system of claim 13, wherein the processor is further programmed to retrieve a profile for the caller to determine a value for the caller.

17. The system of claim 16, wherein processor routes the caller based on the priority assigned to the caller and the value determined for the caller.

18. The system of claim 16, wherein the processor is further programmed to perform one among the steps of increase the priority given to a high valued caller when negative non-vocal physiological data is received from the caller, decrease the priority given to a low valued caller as determined by the profile of the caller when negative non-vocal physiological data is received from the caller, and perform behavior modification techniques on a low valued caller as determined by the profile of the caller when negative non-vocal physiological data is received from the caller.

19. A communication device, comprising:
a transceiver;
a non-vocal physiological detection sensor coupled to the transceiver; and
a processor coupled to the transceiver and programmed to transmit non-vocal physiological data to a third party to alter a call processing procedure at the third party.

20. The communication device of claim 19, wherein the communication device further comprises a presentation device coupled to the transceiver and the processor.

21. The communication device of claim 20, wherein the processor is further programmed to receive instructions from the third party altering a presentation on the presentation device.

22. A communication device, comprising:
a receiver for receiving non-vocal physiological data from at least one transceiver among a plurality of transceivers;
a processor coupled to the receiver for analyzing the non-vocal physiological data; and
a transmitter coupled to the processor and programmed to transmit at least an instruction initiating a mood altering presentation to the at least one transceiver in response to receiving the non-vocal physiological data form the at least one transceiver.
